(19) United States
(12) Patent Application Publication
(10) Pub. No.: US 2026/0304601 A1
(43) Pub. Date: Oct. 1, 2026

(54) OVERLAPPED INTERCONNECT WITH ENHANCED DESIGN

(71) Applicant: Micron Technology, Inc., Boise, ID (US)

(72) Inventor: Jon Karsten Klarqvist, Roseville, MN (US)

(21) Appl. No.: 19/557,607

(22) Filed: Mar. 5, 2026

Related U.S. Application Data
(60) Provisional application No. 63/781,280, filed on Mar. 31, 2025.

(51) Int. Cl. H05K 1/02; G06F 30/398; H05K 1/181; H05K 3/00; G06F 115/12

(52) U.S. Cl. CPC H05K 1/0253; G06F 30/398; H05K 1/181; H05K 3/0005; G06F 2115/12; H05K 2201/0792; H05K 2201/09227

(57) ABSTRACT

Systems, apparatuses, and methods related to an interconnect between an electrical component and a printed circuit board are described. Embodiments of the present technology can include swirling the traces connected the interconnect according to a turn pattern. For example, a printed circuit board trace and a component trace are swirled by a half turn or full turn before connecting to the interconnect. Swirling the traces can generate an inductance which compensates the effects of the capacitance at the interface interconnect.

### CROSS-REFERENCE TO RELATED APPLICATIONS

The present application claims priority to U.S. Provisional Patent Application No. 63/781,280, filed Mar. 31, 2025, the disclosure of which is incorporated herein by reference in its entirety.

### TECHNICAL FIELD

This disclosure relates generally to electronic devices, and more particularly, to electronic devices having enhanced vertically offset interconnects.

### BACKGROUND

Electronic components are vertically arranged, such as components mounted on a substrate (e.g., a printed circuit board (PCB)) or components connected across different layers within silicon, for an electronic device. When a component is interconnected with a PCB, there is often an impedance discontinuity, such as an excess capacitance, at the interconnected interface between the PCB and the component. The impendence discontinuity can lead to signal reflections, a degradation of signal quality, and increased electromagnetic interference.

### BRIEF DESCRIPTION OF THE DRAWINGS

FIG. 1 illustrates a perspective view of a printed circuit board (PCB) with components, in accordance with one or more embodiments of the present technology.

FIG. 2 illustrates interconnect configuration examples of swirling a PCB layer trace and a component layer trace in a similar direction, in accordance with one or more embodiments of the present technology.

FIG. 3 illustrates interconnect configuration examples of swirling a PCB layer trace and a component layer trace in a similar direction, in accordance with one or more embodiments of the present technology.

FIG. 4 illustrates interconnect configuration examples of swirling a partially overlapping PCB layer trace and a component layer trace in different directions, in accordance with one or more embodiments of the present technology.

FIG. 5 illustrates a perspective view of an interconnect with swirled traces, configured in accordance with various embodiments of the present technology.

FIG. 6 is a flow diagram illustrating an example method of designing an interconnect between a PCB and a component, in accordance with one or more embodiments of the present technology.

FIG. 7 is a schematic view of a system that includes an apparatus in accordance with embodiments of the present technology.

### DETAILED DESCRIPTION

An electronic device can include a substrate, such as a printed circuit board (PCB), that provides a structural support and electrical connections for electrical components (e.g., analog components, digital components, integrated circuits, or the like) mounted thereon. The interconnect between a PCB and an electrical component can exhibit excess capacitance generated by the geometrical configuration of the device. The excess capacitance can result in inferior signal integrity and operational errors.

To reduce the effects of the capacitance at the interconnect, embodiments of the present technology can include swirling the traces leading to the interconnect according to a turn pattern. For example, a printed circuit board trace and a component trace are swirled by a half turn or full turn before connecting to the interconnect. Swirling the traces can generate an inductance which compensates the effects of the excess capacitance at the interface interconnect.

By utilizing a swirl trace configuration, interconnect structures can be optimized to improve signal integrity and reduce impedance discontinuities in high-speed or high-frequency operations within electronic devices. As described in detail below, embodiments of the present technology can provide technical advantages over conventional technology and provide at least: 1) an improvement of the signal quality at a PCB and component interconnect; 2) an improvement of the signal quality at a die to component interconnect; 3) an improvement of the signal quality at an interposer interconnect; and 4) enhanced circuit performance by tuning the inductances (self and mutual) and capacitances (self and mutual) of a circuit.

For brevity, the embodiments of the present technology are described herein using components mounted on a PCB. However, it is understood that the technology can be utilized for any vertically offset circuits, such as for circuit devices and their connections (e.g., traces) within a semiconductor die and connected through one or more vertically extending vias. The “interconnect” as described herein can refer to any termination point of a trace, such as a via.

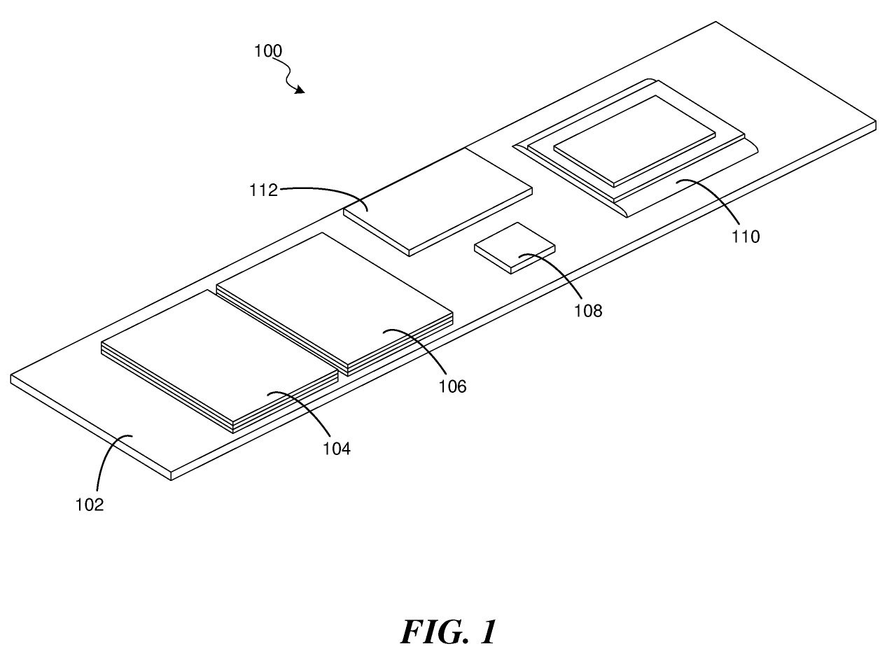

FIG. 1 illustrates a perspective view of electronic device 100 that includes a PCB 102 with mounted components 104, 106, 108, 110, and 112, in accordance with one or more embodiments of the present technology. The components 104, 106, 108, 110, and 112 (e.g., analog components, digital components, integrated circuits, or the like) can be mounted on the PCB 102. Some examples of the components may include, a central processing unit (CPU), a graphics processing unit (GPU), a memory (e.g., a Dynamic Random-Access Memory (DRAM)), a memory controller, a power management integrated circuit (PMIC), and the like.

The mounted components 104, 106, 108, 110, and 112 can interconnect (e.g., by a solder ball(s) of a ball grid array (BGA)) with the PCB 102. The electrical characteristics and signal activity of the components 104, 106, 108, 110, and 112 can cause a capacitance to occur at the interconnect. To compensate for (e.g., reduce or eliminate) the capacitance, a component trace and/or a PCB trace connecting to the interconnect are swirled around the interconnection/termination point. Swirling the trace(s) generates an inductance which compensates for (e.g., reduces or mitigates) the capacitance effect on the interconnect.

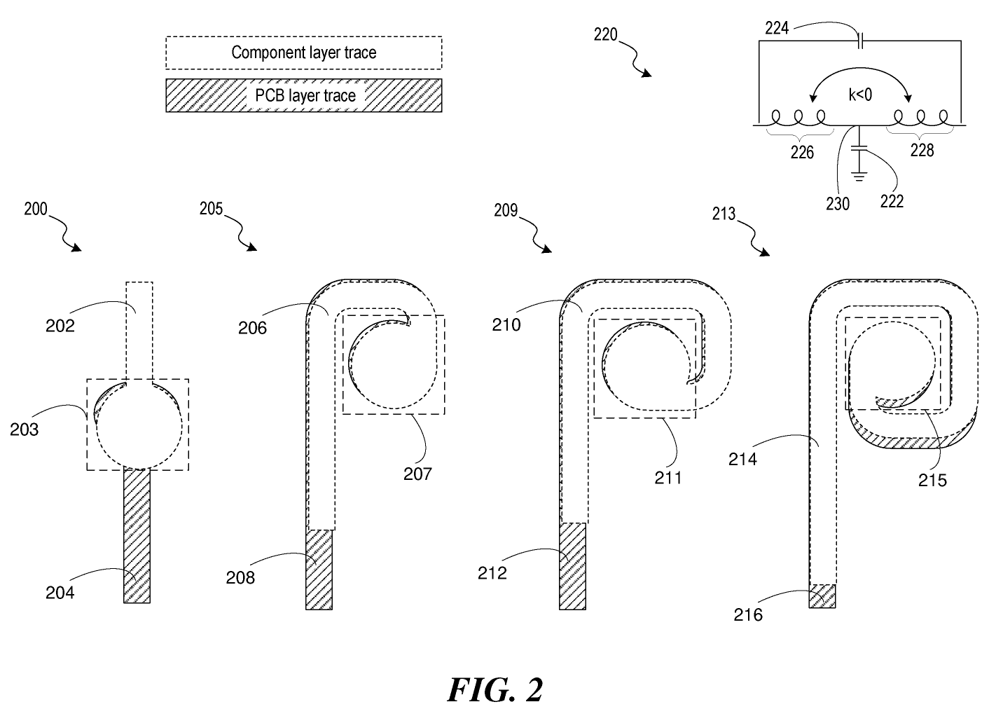

FIG. 2 illustrates interconnect configuration examples of swirling a PCB layer trace and a component layer trace in a similar direction, in accordance with one or more embodiments of the present technology. Interconnect configuration 200 illustrates a component layer trace 202 and a PCB layer trace 204 connected in a non-swirled conventional configuration. A solder ball (not shown) can form a connection point 203 between the component layer trace 202 and the PCB layer trace 204.

Interconnect configuration 205 illustrates a component layer trace 206 and a PCB layer trace 208 connected in an overlapping swirled configuration. The component layer trace 206 and the PCB layer trace 208 swirl in a quarter turn pattern approaching the connection point 207. A solder ball (not shown) can form the connection point 207 between the component layer trace 206 and the PCB layer trace 208.

Interconnect configuration 209 illustrates a component layer trace 210 and a PCB layer trace 212 connected in an overlapping swirled configuration. The component layer trace 210 and the PCB layer trace 212 swirl in a half turn pattern approaching the connection point 211. A solder ball (not shown) can form the connection point 211 between the component layer trace 210 and the PCB layer trace 212.

Interconnect configuration 213 illustrates a component layer trace 214 and a PCB layer trace 216 connected in an overlapping swirled configuration. The component layer trace 214 and the PCB layer trace 216 swirl in a full turn pattern approaching the connection point 215. A solder ball (not shown) can form the connection point 215 between the component layer trace 214 and the PCB layer trace 216.

The component layer traces 206, 210, and 214 and the PCB layer traces 208, 212, and 216 can overlap and swirl in a similar or matching direction with a similar or matching number of turns. The swirled configuration of the traces generates an inductance to compensate for the capacitance formed at the interconnect. The different turn patterns of interconnect configurations 205, 209, and 213 provide different levels of inductive coupling and capacitance control. These various configurations can be used to address specific interconnect requirements between components and a PCB in electronic devices, such as the electronic device 100 described in relation to FIG. 1. Although the PCB layer traces and component layer traces illustrated in FIG. 2 are swirled in a quarter turn, half turn, and full turn patterns, the PCB layer traces 208, 212, and 216 and the component layer traces 206, 210, and 214 can be swirled by any number of turns before reaching the interconnect.

Circuit diagram 220 is an example of a circuit (e.g., a T-Coil circuit) illustrating the electrical components at the interconnect 230. Capacitor 224 represents the excess capacitance formed at the interconnect 230. Capacitor 222 represents the surrounding electrical load of components and circuitry surrounding the interconnect 230. Inductors 226 and 228 represent the inductance generated by swirling the component layer traces 206, 210, and 214 and the PCB layer traces 208, 212, and 216 when approaching the interconnect 230. The coupling coefficient “k” represents the amount of coupling between the inductors 226 and 228. A k value of less than 0, indicates the generated inductance is greater than the capacitance at the interconnect 230.

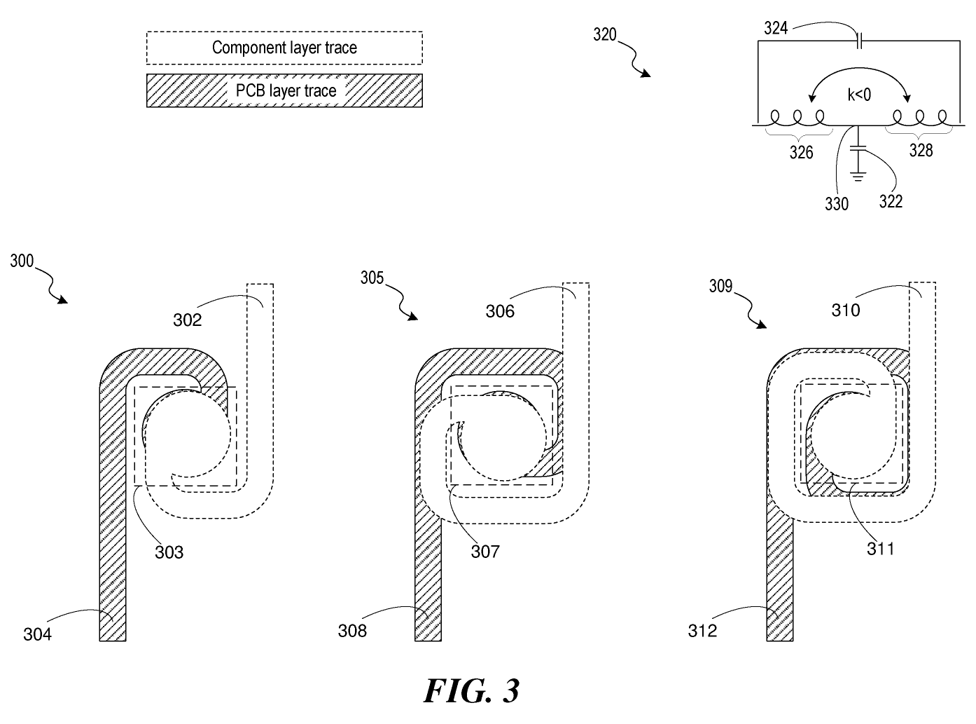

FIG. 3 illustrates interconnect configuration examples of swirling a PCB layer trace and a component layer trace in different directions, in accordance with one or more embodiments of the present technology. Interconnect configuration 300 illustrates a component layer trace 302 and a PCB layer trace 304 connected in a swirled configuration. The component layer trace 302 and the PCB layer trace 304 can swirl in a similar direction in a half turn pattern approaching the connection point 303. For example, the component layer trace 302 swirls in a clockwise direction and the PCB layer trace 304 swirls in a clockwise direction. A solder ball (not shown) can form the connection point 303 between the component layer trace 302 and the PCB layer trace 304.

Interconnect configuration 305 illustrates a component layer trace 306 and a PCB layer trace 308 connected in a partially overlapping swirled configuration. The component layer trace 306 and the PCB layer trace 308 can swirl in a similar direction in a three-quarters turn pattern approaching the connection point 307. For example, the component layer trace 306 swirls in a clockwise direction and the PCB layer trace 308 swirls in a clockwise direction. A solder ball (not shown) can form the connection point 307 between the component layer trace 306 and the PCB layer trace 308.

Interconnect configuration 309 illustrates a component layer trace 310 and a PCB layer trace 312 connected in a partially overlapping swirled configuration. The component layer trace 310 and the PCB layer trace 312 swirl in a similar direction in a full turn pattern approaching the connection point 311. For example, the component layer trace 310 swirls in a clockwise direction and the PCB layer trace 312 swirls in a clockwise direction. A solder ball (not shown) can form the connection point 311 between the component layer trace 310 and the PCB layer trace 312.

The component layer traces 302, 306, and 310 and the PCB layer traces 304, 308, and 312 can partially overlap or not overlap and swirl in different directions with a similar number of turns. The swirled configuration of the traces generates an inductance to compensate for the capacitance formed at the interconnect. The different turn patterns of interconnect configurations 300, 305, and 309 provide different levels of inductive coupling and capacitance control. These various configurations can be used to address specific interconnect requirements between components and a PCB in electronic devices, such as the electronic device 100 described in relation to FIG. 1. Although the PCB layer traces and component layer traces illustrated in FIG. 3 are swirled in a half turn, three-quarters turn, and full turn patterns, the PCB layer traces 304, 308, and 312 and the component layer traces 302, 306, and 310 can be swirled by any number of turns before reaching the interconnect.

Circuit diagram 320 is an example of a circuit (e.g., a T-Coil circuit) illustrating the electrical components at the interconnect 330. Capacitor 324 represents the excess capacitance formed at the interconnect 330 (e.g., interconnect point 203, 207, 211, and 215). In some cases, the excess capacitance is decreased by reducing the overlap of the component layer traces 302, 306, and 310 and the PCB layer traces 304, 308, and 312. Capacitor 322 represents the surrounding electrical load of components and circuitry surrounding the interconnect 330. Inductors 326 and 328 represent the inductance generated by swirling the component layer traces 302, 306, and 310 and the PCB layer traces 304, 308, and 312 when approaching the interconnect 330. The coupling coefficient “k” represents the amount of coupling between the inductors 326 and 328. A k value of less than 0, indicates the generated inductance is greater than the capacitance at the interconnect 330.

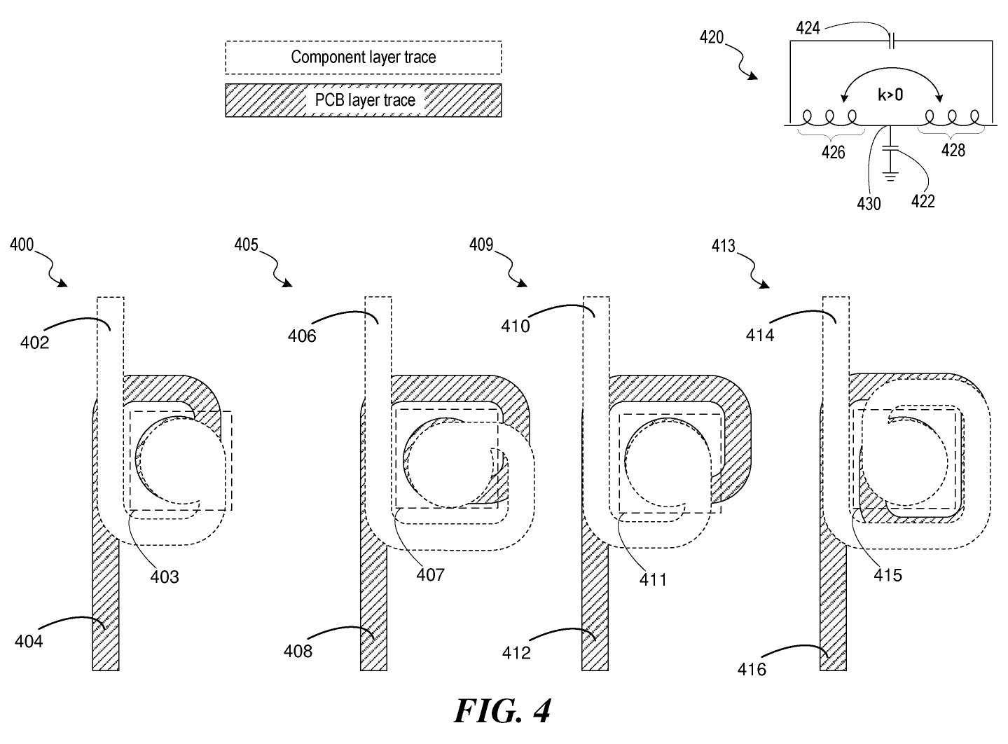

FIG. 4 illustrates interconnect configuration examples of swirling a partially overlapping PCB layer trace and a component layer trace in different directions, in accordance with one or more embodiments of the present technology. Interconnect configuration 400 illustrates a component layer trace 402 and a PCB layer trace 404 connected in a partially overlapping swirled configuration. The component layer trace 402 and the PCB layer trace 404 can swirl in opposite directions in a quarter turn pattern approaching the connection point 403. For example, the component layer trace 402 swirls in a counterclockwise direction and the PCB layer trace 404 swirls in a clockwise direction. A solder ball (not shown) can form the connection point 403 between the component layer trace 402 and the PCB layer trace 404.

Interconnect configuration 405 illustrates a component layer trace 406 and a PCB layer trace 408 connected in a partially overlapping swirled configuration. The component layer trace 406 and the PCB layer trace 408 can swirl in opposite directions in a half turn pattern approaching the connection point 407. For example, the component layer trace 406 swirls in a counterclockwise direction and the PCB layer trace 408 swirls in a clockwise direction. A solder ball (not shown) can form the connection point 407 between the component layer trace 406 and the PCB layer trace 408.

Interconnect configuration 409 illustrates a component layer trace 410 and a PCB layer trace 412 connected in a partially overlapping swirled configuration. The component layer trace 410 and the PCB layer trace 412 can swirl in opposite directions with a different turn pattern while approaching the connection point 411. For example, the component layer trace 410 swirls in a counterclockwise direction with a quarter turn and the PCB layer trace 412 swirls in a clockwise direction with a half turn. A solder ball (not shown) can form the connection point 411 between the component layer trace 410 and the PCB layer trace 412.

Interconnect configuration 413 illustrates a component layer trace 414 and a PCB layer trace 416 connected in a partially overlapping swirled configuration. The component layer trace 414 and the PCB layer trace 416 swirl in opposite directions in a full turn pattern approaching the connection point 415. For example, the component layer trace 414 swirls in a counterclockwise direction and the PCB layer trace 416 swirls in a clockwise direction. A solder ball (not shown) can form the connection point 415 between the component layer trace 414 and the PCB layer trace 416.

The component layer traces 402, 406, 410, and 414 and the PCB layer traces 404, 408, 412, and 416 can partially overlap and swirl in different directions with a similar number of turns. In some cases, the component layer traces 402, 406, 410, and 414 and the PCB layer traces 404, 408, 412, and 416 can have a different number of turns or turn pattern, as illustrated by interconnect configuration 409. The swirled configuration of the traces generates an inductance to compensate for the capacitance formed at the interconnect. The different turn patterns of interconnect configurations 400, 405, 409, and 413 provide different levels of inductive coupling and capacitance control. These various configurations can be used to address specific interconnect requirements between components and a PCB in electronic devices, such as the electronic device 100 described in relation to FIG. 1. Although the PCB layer traces and component layer traces illustrated in FIG. 3 are swirled in a quarter turn, half turn, three-quarters turn, and full turn patterns, the PCB layer traces 404, 408, 412, and 416 and the component layer traces 402, 406, 410, and 414 can be swirled by any number of turns before reaching the interconnect.

Circuit diagram 420 is an example of a circuit (e.g., a T-Coil circuit) illustrating the electrical components at the interconnect 430. Capacitor 424 represents the excess capacitance formed at the interconnect 430 (e.g., interconnect point 403, 407, and 411). In some cases, the excess capacitance is decreased by reducing the overlap of the component layer traces 402, 406, 410, and 414 and the PCB layer traces 404, 408, 412, and 416. Capacitor 422 represents the surrounding electrical load of components and circuitry surrounding the interconnect 430. Inductors 426 and 428 represent the inductance generated by swirling the component layer traces 402, 406, 410, and 414 and the PCB layer traces 404, 408, 412, and 416 when approaching the interconnect 430. The coupling coefficient “k” represents the amount of coupling between the inductors 426 and 428. A k value of greater than 0, indicates the generated inductance is less than the capacitance at the interconnect 430.

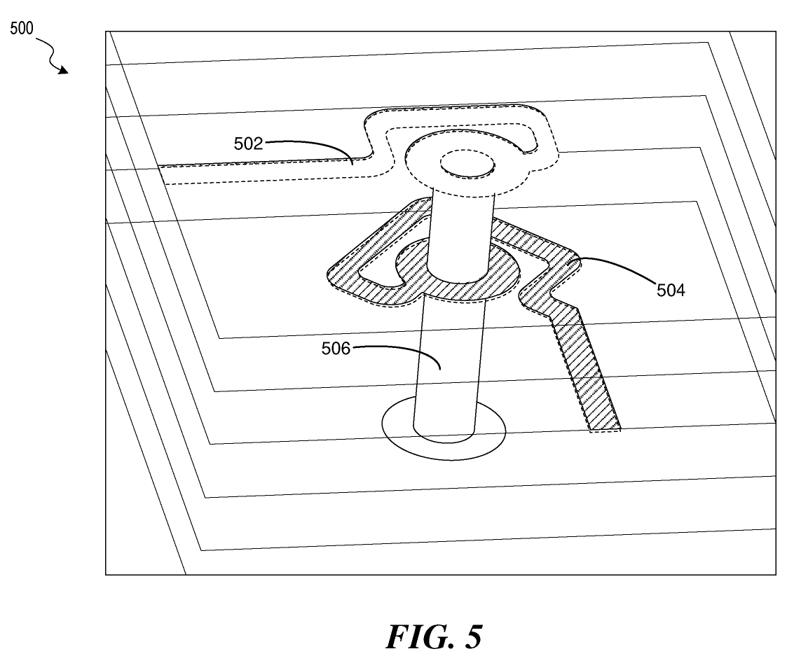

FIG. 5 illustrates a perspective view of an interconnect 500 with swirled traces 502 and 504, configured in accordance with various embodiments of the present technology. The trace 502 and the trace 504 are interconnected through a via 506. The trace 502 is positioned on a different layer of the interconnect 500 than the trace 504.

The trace 502 and the trace 504 can swirl in opposite directions with a different turn pattern while approaching the via 506. For example, the trace 502 swirls in a clockwise direction with a half turn and the trace 504 swirls in a counterclockwise direction with a three-quarters turn. In some cases, the traces 502 and 504 have a similar turn pattern and swirl in the same direction. This configuration may allow for controlled inductance and capacitance at the interface between different layers of a component, such as a package to die interconnect or interposer interconnects.

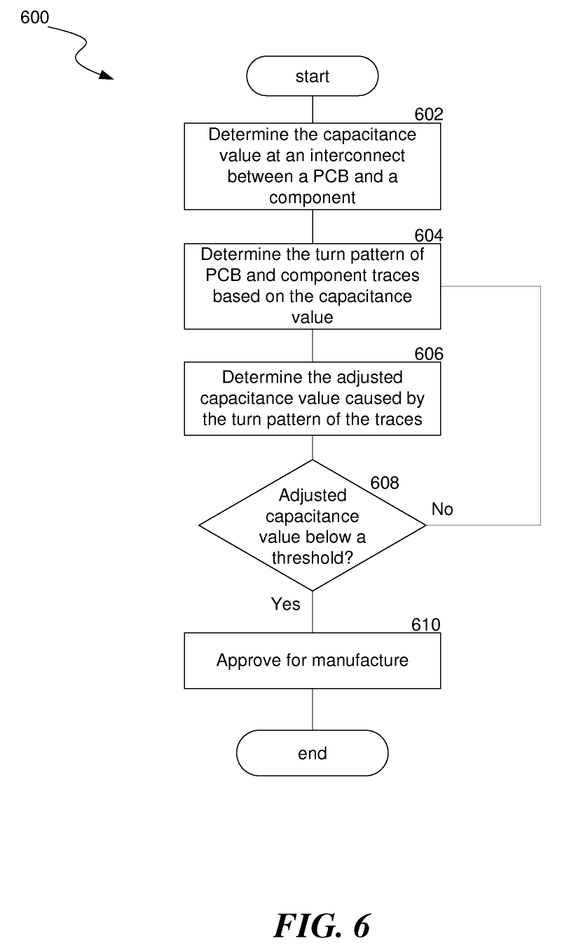

FIG. 6 is a flow diagram illustrating an example method of designing an interconnect between a PCB and a component, in accordance with one or more embodiments of the present technology. The method 600 can determine the turn pattern of traces approaching an interconnect (e.g., termination point of a trace). The turn pattern leading to a termination point of a trace is based on the capacitive coupling that occurs when a termination point is vertically connected between two vertically offset traces. The turns of the traces leading to the termination point generate an inductance at the termination point to reduce the effect of the capacitive coupling. The traces can be turned within a threshold dimension of the termination point to generate the inductance.

At block 602, the method 600 can include determining the capacitance value at an interconnect between the PCB and the component. In some cases, electromagnetic simulation software may be employed to model the interconnect and estimate the capacitance value based on the geometry and materials of the PCB, component, and interconnect.

At block 604, the method 600 can include determining the turn pattern for a PCB trace and a component trace approaching the interconnect based on the capacitance value. The turn pattern can include the turn direction of the trace, the number of turns in the trace, and/or whether the traces overlap, partially overlap, or do not overlap. In some cases, the turn pattern is based on the load and signal bandwidth of the circuit surrounding the interconnect.

A machine learning or artificial intelligence (ML/AI) module may be configured to analyze the capacitance at an interconnect and determine the turn pattern for the traces approaching the interconnect. The ML/AI learning module may be configured to analyze the capacitance at the interconnect and determine the turn pattern of the traces based on at least one ML/AI model trained on at least one dataset reflecting previous user determined turn patterns for traces based on capacitance values. The at least one ML/AI algorithm (and model) may be stored locally at databases and/or externally at databases (e.g., cloud databases and/or cloud servers). Client devices (e.g., personal computers, smart phones, tablets, etc.) may be equipped to access these ML/AI algorithms and intelligently determine the turn pattern for PCB and component traces based on at least one ML/AI model that is trained on historical trace design parameters. For example, trace design history may be collected to train a ML/AI model to automatically determine the turn direction, number of turns, and amount of overlap of each trace connecting to an interconnect based on the capacitance at the interconnect affecting the signal integrity of the circuit.

As described herein, a ML/AI model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML/AI models may be located on the client device, service device, a network appliance (e.g., a firewall, a router, etc.), or some combination thereof. The ML/AI models may process historical parameters of trace designs and other data stores (e.g., PCB standards, component standards, etc.) to analyze the capacitance at the interconnect and design the PCB trace and component trace. Based on an aggregation of data from a trace design database, external/internal portals, and other user data stores, at least one ML/AI model may be trained and subsequently deployed to automatically design PCB and component traces. The trained ML model may be deployed to one or more devices. As a specific example, an instance of a trained ML model may be deployed to a server device and to a client device. The ML model deployed to a server device may be configured to be used by the client device when, for example, the client device is connected to the internet. Conversely, the ML model deployed to a client device may be configured to be used by the client device when, for example, the client device is not connected to the internet. In some instances, a client device may not be connected to the internet but still configured to receive satellite signals with trace design information. In such examples, the ML model may be locally cached by the client device.

At a step 606, the method 600 can include determining the adjusted capacitance value based on the added inductance caused by the turn pattern of the traces. The determination can be based on simulation testing with an electromagnetic simulation tool to model the behavior of the swirled traces and calculate the resulting capacitance at the interconnect. The simulation results can show the reduction in interconnect capacitance by adding turns to the PCB trace and the component trace.

At decision block 608, method 600 can include determining whether the adjusted capacitance value is below a threshold. If the adjusted capacitance value is not below the threshold, the method 600 can include adjusting the turn pattern of the PCB trace and component trace, as illustrated by the feedback loop to block 604. If the adjusted capacitance value is below the threshold, at block 610, method 600 can include approving the trace design for manufacture.

Based on the approval, the trace design can be utilized to manufacture the traces of the PCB and the component. For example, the trace design can be provided to the PCB and component manufacturers. When manufacturing the PCB and component according to the approved design, the PCB and component traces can be swirled according to the trace design (e.g., the interconnect configurations 200, 205, 209, 213, 300, 305, 309, 400, 405, 409, and 413 of FIGS. 2-4).

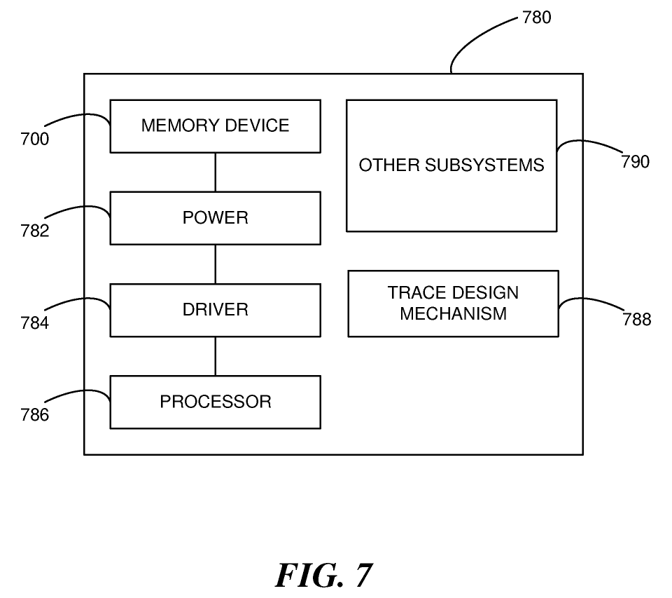

FIG. 7 is a schematic view of a system that includes an apparatus in accordance with embodiments of the present technology. Any one of the foregoing apparatuses (e.g., memory devices) associated with the PCBs described above with reference to FIGS. 1-6 can be incorporated into or implemented in memory (e.g., a memory device 700) or any of a myriad of larger and/or more complex systems, a representative example of which is system 780 shown schematically in FIG. 7. The system 780 can include the memory device 700, a power source 782, a driver 784, a processor 786, a trace design mechanism 788, and/or other subsystems or components 790. The trace design mechanism 788 can use ML/AI models to determine the number of turns, direction of the turns, and/or overlap amount of the PCB and component traces based on the capacitance value at the interconnect between the PCB and component (as described in FIG. 6).

The memory device 700 can include features generally similar to those of the apparatus described above with reference to FIGS. 1-6 and can therefore include various features for performing a direct read request from a host device. The resulting system 780 can perform any of a wide variety of functions, such as memory storage, data processing, and/or other suitable functions. Accordingly, representative systems 780 can include, without limitation, hand-held devices (e.g., mobile phones, tablets, digital readers, and digital audio players), computers, vehicles, appliances and other products. Components of the system 780 may be housed in a single unit or distributed over multiple, interconnected units (e.g., through a communications network). The components of the system 780 can also include remote devices and any of a wide variety of computer readable media.

From the foregoing, it will be appreciated that specific embodiments of the technology have been described herein for purposes of illustration, but that various modifications may be made without deviating from the technology. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the present technology and associated technology can encompass other embodiments not expressly shown or described herein.

In the illustrated embodiments above, the apparatuses have been described in the context of DRAM devices. Apparatuses configured in accordance with other embodiments of the present technology, however, can include other types of suitable storage media in addition to or in lieu of DRAM devices, such as, devices incorporating NAND-based or NOR-based non-volatile storage media (e.g., NAND flash), magnetic storage media, phase-change storage media, ferroelectric storage media, etc.

The term “processing” as used herein includes manipulating signals and data, such as writing or programming, reading, erasing, refreshing, adjusting or changing values, calculating results, executing instructions, assembling, transferring, and/or manipulating data structures. The term data structures includes information arranged as bits, words or code-words, blocks, files, input data, system generated data, such as calculated or generated data, and program data. Further, the term “dynamic” as used herein describes processes, functions, actions or implementation occurring during operation, usage or deployment of a corresponding device, system or embodiment, and after or while running manufacturer’s or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to FIGS. 1-7.

We claim:

1. An electronic device comprising:
a printed circuit board including a first trace;
a component mounted on the printed circuit board and including a second trace,
wherein the first trace and the second trace are connected by an interconnect,
wherein the first trace is constructed with a first turn pattern,
wherein the second trace is constructed with a second turn pattern, and
wherein the first turn pattern of the first trace and the second turn pattern of the second trace generate an inductance at the interconnect to compensate a capacitance at the interconnect.

2. The electronic device of claim 1, wherein the first turn pattern includes a quarter turn, half turn, three-quarters turn, full turn, or multiple turns in a first direction.

3. The electronic device of claim 2, wherein the second turn pattern includes a quarter turn, half turn, three-quarters turn, full turn, or multiple turns in a second direction.

4. The electronic device of claim 3, wherein:
the first direction of the first turn pattern is different from the second direction of the second turn pattern, and
the first turn pattern includes a different number of turns than the second turn pattern.

5. The electronic device of claim 3, wherein:
the first direction of the first turn pattern matches the second direction of the second turn pattern, and
the first turn pattern includes a matching number of turns as the second turn pattern.

6. The electronic device of claim 1, wherein the first trace and the second trace at least partially overlap when approaching the interconnect.

7. The electronic device of claim 1, wherein the first turn pattern and the second turn pattern are based on a capacitance value measured at the interconnect.

8. The electronic device of claim 1, wherein the first trace and the second trace are connected at the interconnect by a solder ball.

9. The electronic device of claim 1, wherein:
the interconnect is a via, and
the first trace and the second trace are connected to the via at different locations.

10. A memory device comprising:
a semiconductor substrate;
a trace on the semiconductor substrate,
wherein the trace on the semiconductor substrate is constructed with a turn pattern leading to a termination point, and
wherein the turn pattern of the trace on the semiconductor substrate is configured to generate an inductance at the termination point to compensate a capacitance at the termination point, when the termination point is vertically connected to a coupled trace that is vertically offset from the trace on the semiconductor substrate.

11. The memory device of claim 10, wherein the turn pattern of the trace on the semiconductor substrate includes a quarter turn, half turn, three-quarters turn, full turn, or multiple turns in a direction.

12. The memory device of claim 11, wherein:
the turn pattern is first turn pattern,
the coupled trace is constructed with a second turn pattern leading to the termination point,
the trace on the semiconductor substrate and the coupled trace overlap or partially overlap when approaching the termination point, and
the first turn pattern and the second turn pattern are based on a capacitance value measured at the termination point.

13. The memory device of claim 12, wherein:
a first direction of the first turn pattern is different from a second direction of the second turn pattern, and
the first turn pattern includes a different number of turns than the second turn pattern.

14. The memory device of claim 12, wherein
a first direction of the first turn pattern matches a second direction of the second turn pattern, and
the first turn pattern includes a matching number of turns as the second turn pattern.

15. A method for controlling a capacitance at an interconnect between a printed circuit board and a component, the method comprising:
determining a capacitance value of the capacitance at the interconnect between the printed circuit board and the component, wherein a first trace of the printed circuit board and a second trace of the component connect to the interconnect; and
determining a first turn pattern for the first trace and a second turn pattern for the second trace based on the capacitance value, wherein the first turn pattern and the second turn pattern generate an inductance at the interconnect to compensate the capacitance at the interconnect.

16. The method of claim 15, further comprising:
determining a second capacitance value at the interconnect based on the inductance generated by the first turn pattern and the second turn pattern; and
in response to the second capacitance value being below a threshold value, approving the first turn pattern and the second turn pattern for manufacturing.

17. The method of claim 15, wherein:
a first direction of the first turn pattern is different from a second direction of the second turn pattern, and
the first turn pattern includes a different number of turns than the second turn pattern.

18. The method of claim 17, wherein:
the first direction of the first turn pattern matches the second direction of the second turn pattern, and
the first turn pattern includes a matching number of turns as the second turn pattern.

19. The method of claim 15, further comprising:
manufacturing the component and the printed circuit board based on:
swirling the first trace according to the first turn pattern;
swirling the second trace according to the second turn pattern; and
connecting the first trace to the second trace at the interconnect with a solder ball.

20. The method of claim 15, wherein the first turn pattern and the second turn pattern are identified using a computing model configured to estimate inductance values associated with turning traces at the interconnect based on at least one dataset representative of previous inductance results associated with previously determined turn patterns of printed circuit board trances and component traces.
